(19) United States
(12) Patent Application Publication
(10) Pub. No.: US 2019/0343066 A1
(43) Pub. Date: Nov. 14, 2019

(54) Sifting Device for Efficient Animal Waste Removal

(71) Applicant: Shenzhen Petao Technology Co. Ltd., Shenzhen (CN)

(72) Inventors: Chao FAN, Hong Kong (HK); Xuran CHENG, Hong Kong (HK)

(21) Appl. No.: 15/978,265

(22) Filed: May 14, 2018

(51) Int. Cl. A01K 1/01

(52) U.S. Cl. CPC A01K 1/0114; A01K 1/0152

(57) ABSTRACT

A sifting device having four sieve-like layers for separating an unsoiled litter material from an animal waste comprises at least two nested trays configured to stack together. Each nested tray comprises a first screen tray and a second screen tray stackable and rotatable to each other, and each of the first and second screen trays has a base with a plurality of openings thereon. Each individual opening is sized to permit the unsoiled litter material to pass through, and to prevent the animal waste from passing through. The openings on the screen trays are arranged in a concentric, circular and intermittent manner. By rotating the screen tray, the sifting device can allow the unsoiled litter material to pass through or form an imperforate base by blocking all the openings. This provides an advantage of operation simplicity with minimized risk of clogging.

### FIELD OF THE INVENTION

The present invention relates generally to a device for sifting animal waste, and more particularly, to an improved device having four sieve-like layers for removing animal waste from litter material efficiently.

### BACKGROUND

A potty device with a shape similar to a tray or a bowl can be used by pet animals to excrete waste. Pet owner can train the pet animal, such as domestic cat, to use the potty and dispose the excrement within the interior of the potty. In order to give the pet animal a feeling similar to the outdoor environment, the potty is usually filled with litter material, such as sand. After the pet animal use the potty, the pet owner has to clean the potty and scoop the animal excrement or coagulated litter.

The process of removing animal waste is not a pleasant experience. Pet owners typically use porous scoops to shovel through the litter material line by line. The use of porous scoops, however, is not efficient for four reasons. First, the dense and heavy animal waste exerts frictional resistance and hinders shoveling. Secondly, clumps and solid waste have to be tossed right away when they are scooped, otherwise the waste can be wedged and built-up within the scoop causing the pet owner to shovel repeatedly. Thirdly, the pet owners have to spend time filtering the clean litter material each time before tossing the waste. Lastly, clumps can be broken into debris when shoveling and takes additional time to clean the debris.

Sifting device has been used in various occasions for separating wanted elements from unwanted material. Employing this device for removing animal waste is also a possible solution to improve the efficiency. The pet owner can easily sift the animal waste from litter material with one attempt without scooping the waste repeatedly. However, conventional designs usually have flanges or ribs on the bottom of the sifting device, which can be jammed or clogged by litter clumps easily and are difficult to clean. Furthermore, the sifting device usually comprises several layers of tray. If the trays are arranged incorrectly, there may be accidental leakage of the litter material or undesirable contact with the soiled litter material.

Thus, what is needed is a device using an intelligent sifting method for filtering the animal waste while addresses secondary pollution and risk of leakage. Furthermore, other desirable features and characteristics will become apparent from the subsequent detailed description and the appended claims, taken in conjunction with the accompanying drawings and this background of the disclosure.

### SUMMARY OF THE INVENTION

In the present disclosure, a sifting device for separating an unsoiled litter material from an animal waste is provided.

The sifting device is structured with at least two nested trays configured to stack together. Each nested tray comprises a first screen tray and a second screen tray stackable and rotatable to each other, and each of the first and second screen trays has a base with a plurality of openings thereon.

Each individual opening is sized to permit the unsoiled litter material to pass through, and to prevent the animal waste with a substantially larger size from passing through. The plurality of openings on the first screen tray is arranged in a concentric, circular and intermittent manner to form a first pattern; and similarly the plurality of openings on the second screen tray is arranged in a concentric, circular and intermittent manner to form a second pattern.

The plurality of openings on the first screen tray is blocked by the plurality of openings on the second screen tray to form an imperforate base when the first and second screen trays are stacked together and positioned to have the first and second patterns entirely non-overlapped; and the first and second screen trays are rotatable to arrange the first and second patterns to be at least partially overlapped such that the base becomes a perforated base for allowing the unsoiled litter material to pass through.

Preferably, a bottom nested tray of the at least two nested trays is arranged to form the imperforate base, and an uppermost nested tray of the at least two nested trays is arranged to form the perforated base for collecting the litter material in a nested tray lower than the uppermost nested tray, thereby enabling the uppermost nested tray to be emptied and cleaned after allowing the animal waste to be collected therein.

Preferably, the first and second patterns are selected such that the first pattern is mirrored from the second pattern. The individual opening has a width not more than 7 mm. The plurality of openings is arranged along a plurality of concentric circular tracks having increasing radii from an innermost circular track to an outermost circular track intermittently. Each concentric circular track is alternatively formed by annular openings and non-opening portions.

Preferably, each of the first and second screen trays has sidewalls bulging from the base upwardly and slightly outwardly to enable one screen tray stacked atop another screen tray to form an individual nested tray. Both the first second screen tray have one or more grips flared laterally outward from an upper rim of the sidewalls for facilitating lifting an uppermost nested tray of the at least two nested trays. The at least two nested trays are substantially identical to and interchangeable with each other.

Other aspects of the present invention are disclosed as illustrated by the embodiments hereinafter.

### BRIEF DESCRIPTION OF THE DRAWINGS

The appended drawings, where like reference numerals refer to identical or functionally similar elements, contain figures of certain embodiments to further illustrate and clarify various aspects, advantages and features of the sifting device and method disclosed herein. It will be appreciated that these drawings depict only certain embodiments of the invention and are not intended to limit its scope. The sifting device and method disclosed herein will be described and explained with additional specificity and detail through the use of the accompanying drawings in which:

FIG. 1 is a perspective view of the sifting device according to certain embodiments of the present disclosure.

FIG. 2 is a perspective view of the sifting device according to certain embodiments of the present disclosure filled with litter material.

FIG. 3 is an exploded perspective view of the sifting device of FIG. 1.

FIG. 4 is a perspective view of the uppermost nested trays of the sifting device of FIG. 1.

FIG. 5 is a top view of the first screen tray of the sifting device of FIG. 1.

FIG. 6 is a top view of the second screen tray of the sifting device of FIG. 1.

FIG. 7 is a top view of the first and second screen trays stacked together without rotating.

FIG. 8 is a top view of the first and second screen trays stacked together with the first screen tray rotated by an angle less than 45 degrees anticlockwise.

FIG. 9 is a top view of the first and second screen trays stacked together with the second screen tray rotated by an angle of 45 degrees anticlockwise.

FIG. 10 is a top view of the openings on the base of the first screen tray of the sifting device of FIG. 1.

FIG. 11 is a top view of the openings on the base of the first screen tray of the sifting device according to second embodiments of the present disclosure.

FIG. 12 is a top view of the openings on the base of the second screen tray of the sifting device according to second embodiments of the present disclosure.

FIG. 13 is a 3D CAD model of the sifting device of FIG. 1.

FIG. 14 is an exploded 3D CAD model of the sifting device of FIG. 1.

### DETAILED DESCRIPTION

The present disclosure relates to an improved sifting device having four sieve-like layers for sifting animal waste from litter material efficiently. More specifically, the present disclosure provides a sifting device with at least four sieve-like layers of screen trays stackable and rotatable to each other to form a potty that can be used by pet animals to excrete waste. The sifting device of the present invention is applicable but not limited to animal waste handling. It should be appreciated that a vast number of variations exist. The dimensions provided in the following description are not intended to be limited to those described herein; rather, the dimensions are exemplary of possible embodiments of the present invention, as exact measurements and configurations will depend on size and structure of the sifting device to be improved.

The following terms are used herein in the specification and appended claims. The term “litter material” as used herein is any granular or particulate material that serves as a waste holding media into which the animal may deposit bodily wastes, such as: sand, dried clay, or cat litter. The term “unsoiled litter material” as used herein refers to the litter material that is substantially uncontaminated. The term “animal waste” as used herein means both animal excrement and clumped lifter material, which is the litter material after in contact with animal excrement or urine.

When introducing elements of the present disclosure or the preferred embodiments thereof, the articles “a”, “an” and “the” are not intended to denote a limitation of quantity, but rather to denote the presence of at least one of the item being referred to. Further, the terms “comprises”, “comprising”, “including” and “having” are intended to be inclusive and mean that there may be additional elements other than the listed elements.

Terms such as “upper”, “lower”, “inner”, “outer” and variations thereof herein are used for ease of description to explain the positioning of one element relative to a second element, and are not intended to be limiting to a specific orientation or position.

Terms such as “first”, “second”, and the like, are used to describe various elements, regions, sections, etc. and are not intended to be limiting.

Furthermore, and as described in subsequent paragraphs, the specific to configurations illustrated in the drawings are intended to exemplify embodiments of the disclosure and that other alternative configurations are possible.

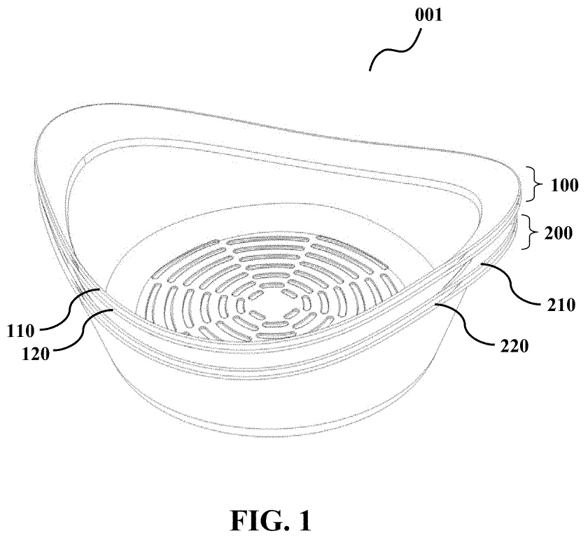

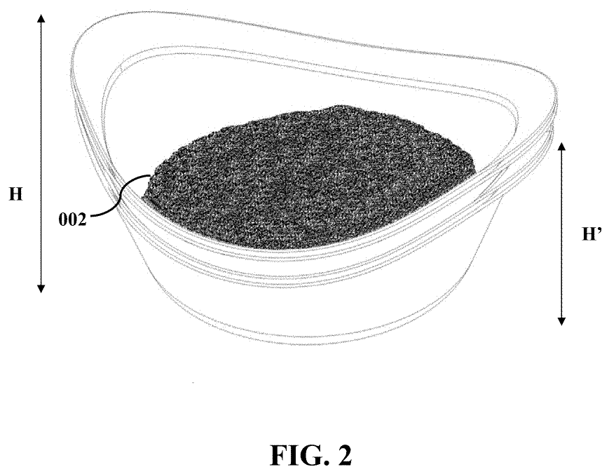

FIG. 1 is a perspective view of the sifting device 001 according to the present invention. The sifting device 001 can be used for separating unsoiled litter material with substantially smaller size from animal waste with a substantially larger size, such that the animal waste can be separated and collected for disposal. Preferably, the sifting device 001 comprises two substantially identical and interchangeable nested trays (100 and 200), which are referred to as an uppermost nested tray 100 and a bottom nested tray 200. Although two nested trays are shown in FIG. 1 for explaining the structure of the sifting device 001, the present invention is not limited only to using two nested trays, and may comprise more than two nested trays. The at least two nested trays are configured to stack together with the uppermost nested tray 100 on top, while the bottom nested tray 200 at the lowest of the stack. The uppermost nested tray 100 further comprises a first screen tray 110 and a second screen tray 120, and the bottom nested tray 200 also comprises a first screen tray 210 and a second screen tray 220. The first and second screen trays are both stackable and rotatable to each other. As shown in FIG. 2, the sifting device 001 is filled with litter material 002, which is a waste holding media for the animal to deposit bodily wastes such as animal excrement or urine.

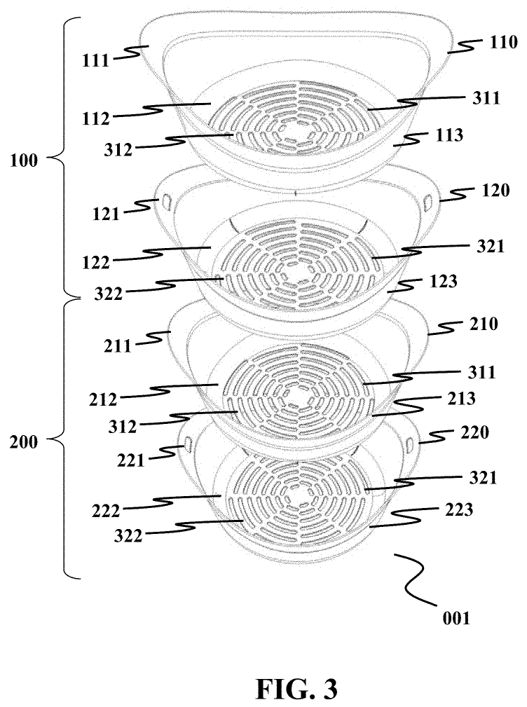

The structure of the present invention is illustrated with the aid of FIG. 3, which depicts an exploded view of the sifting device 001. Each screen tray (110, 120, 210, and 220) is a sieve-like layer configured to have a base (112, 122, 212, and 222) with a plurality of openings 311, 321 thereon, and has sidewalls (113, 123, 213, and 223) bulging from the base (112, 122, 212, and 222) upwardly and slightly outwardly to enable one screen tray stacked atop another screen tray to form a nested tray 100, 200. Each screen tray (110, 120, 210, and 220) has one or more grips (111, 121, 211, and 222) flared laterally outward from an upper rim of the sidewalls (113, 123, 213, and 223) for facilitating the lifting an uppermost nested tray 100 and the rotating of a screen tray. Between any two openings on the base, there is a non-opening region 312, 322. The screen trays (110, 120, 210, and 220) are circular in shape such that each screen trays are rotatable to each other. The sifting device 001 can be sized specifically for each type of animal, and according to one embodiment, the sifting device 001 for domestic cats is approximately 50.2 cm (L)×41.9 cm (W)×22.6 cm (H) when all the screen trays are stacked, and the size of each screen trays (110, 120, 210, and 220) is approximately 50.2 cm (L)×41.9 cm (W)×14.7 cm (H′). The sifting device 001 of the present disclosure can be made from plastic, wood, or metal. Preferably, the sifting device 001 is made from plastic such that the sifting device 001 is light weight and easy to clean.

The sifting device 001 is first configured to have both the uppermost nested tray 100 and the bottom nested tray 200 at a “close” mode to prevent any material to pass through each nested tray. The uppermost nested tray 100 partially filled with the litter material 002 allows the deposit of animal waste therein. After the animal, such as a domestic cat, has used the sifting device 001 by depositing animal waste, the uppermost nested tray 100 is then configured to an “open” mode to permit the unsoiled litter material 002 to pass through, and to prevent the animal waste with a substantially larger size from passing through. By lifting the upper nested tray 100, the litter material 002 is allowed to fall downwardly from the uppermost nested tray 100 to the bottom nested tray 200, while the animal waste is retained in the uppermost nested tray 100. Therefore, the unwanted animal waste can be separated from the litter material 002 for cleaning with one attempt. The uppermost nested tray 100 can also at that time be washed to maintain the hygiene of the sifting device 001. The chance of jamming or clogging is immaterial, as there is no slot for trapping the litter material 002 or animal waste. Lastly, the uppermost nested tray 100 is configured to “close” mode, and the bottom nested tray 200 with the litter material 002 is then placed atop the now-emptied and cleaned upper nested tray 100 to reassembly the sifting device 001 for reuse. Therefore, the positions of the two nested trays are reversed. The uppermost nested tray 100 is now positioned at the bottom and is referred to as “bottom nested tray” thereafter, whereas the bottom nested tray 200 is now positioned at the top and is referred to as “uppermost nested tray” thereafter. The entire operation of the sifting device 001 is simple. The whole cleaning cycle takes less than 30 seconds, vis-à-vis at least 5 minutes for using a scoop to clean the animal waste line by line.

As the two nested trays (100, 200) are substantially identical to and interchangeable with each other, for simplicity, the following detailed description provides the structure of the uppermost nested tray 100, and it is apparent that the description is also applicable to the bottom nested tray 200.

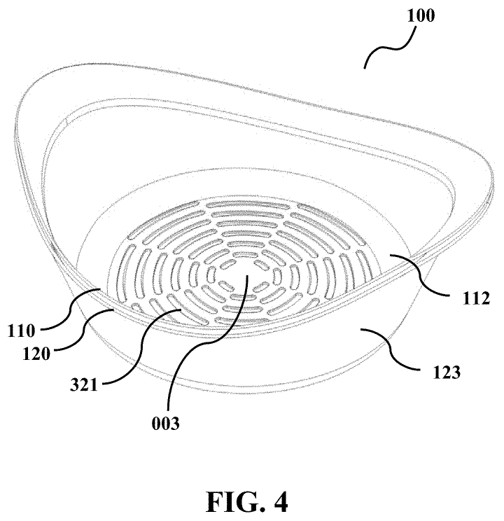

FIG. 4 provides the uppermost nested tray 100 in accordance with the present invention. The uppermost nested tray 100 is formed by stacking the first screen tray 110 atop the second screen tray 120. Each screen trays has a base 112 with a plurality of openings 321 thereon. The openings 321 are arranged in a concentric circular manner with respect to a center 003. The base 112 is circular in shape to allow a smooth rotation of each screen tray.

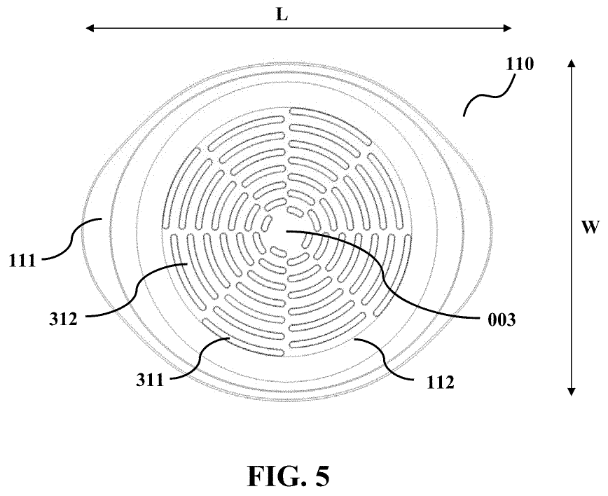

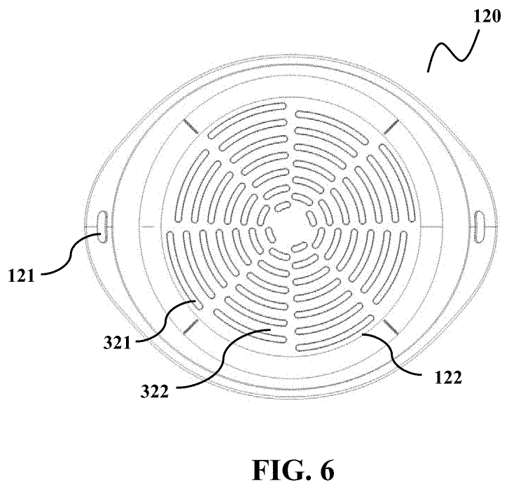

The top view of the first screen tray 110 is shown in FIG. 5. The plurality of openings 321 on the first screen tray 110 is arranged in a concentric, circular and intermittent manner to form a first pattern. Similarly, the top view of the second screen tray 120 is shown in FIG. 6. The plurality of openings 321 on the second screen tray 120 is also arranged in a concentric, circular and intermittent manner to form a second pattern. The uppermost nested tray 100 can be configured to a “close” mode or an “open” mode by rotating the first or second screen tray 110, 120 to arrange the first and second patterns accordingly.

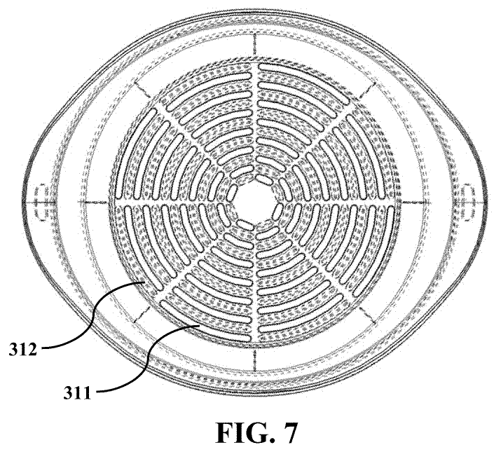

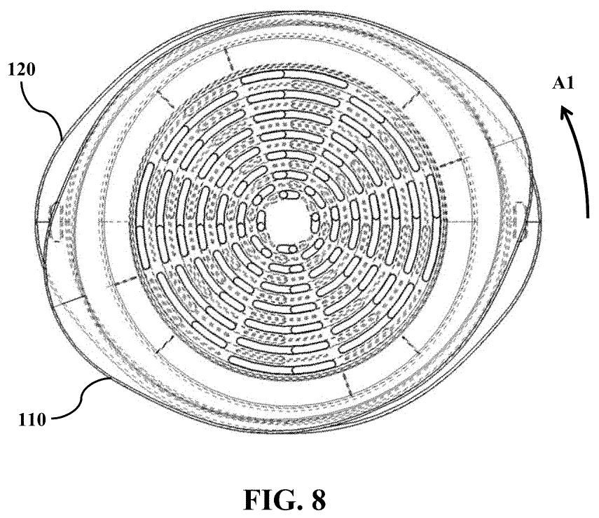

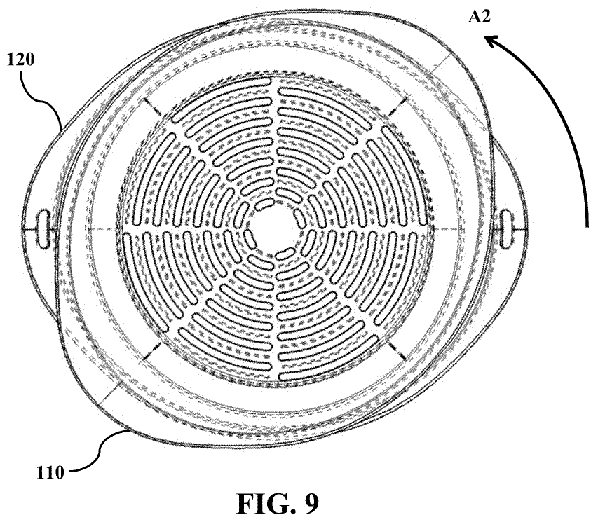

Now refer to FIGS. 7-9, the top view of the first and second screen trays 110, 120 stacked together is shown. Dotted lines are used in FIGS. 7-9 to depict the corresponding structure of the second screen tray 120 placed under the first screen tray 110. FIG. 7 is the configuration of a “close” mode where the first and second screen trays 110, 120 are stacked together without rotation. In this configuration, the plurality of openings 321 on the first and second screen trays 110, 120 are positioned entirely non-overlapped so as to block the plurality of openings 321 of each other. Therefore, the first and second screen trays 110, 120 are stacked together and positioned to have the first and second patterns entirely non-overlapped to form an imperforate base. FIG. 8 is the configuration of a partially “opened” mode by rotating either the first or second screen trays 110, 120 by an angle A1 such that the plurality of openings 321 on the first and second screen trays 110, 120 are partially overlapped. When the angle of rotation is further increases to an angle A2, as depicted in FIG. 9, the plurality of openings 321 on the first and second screen trays 110, 120 are overlapped so as to allow the unsoiled litter material with substantially smaller size to pass through the openings 321 from the first screen tray 110 to the second screen tray 120. In this configuration of an “open” mode, the first and second patterns are overlapped to form a perforate base. The foregoing configuration has the advantage that just a simple rotation of the first and second screen trays 110, 120 can enable the uppermost nested tray 100 to switch between a “close” mode and an “open” mode. The sifting device 001 can be designed in accordance with this configuration with as few as four layers of screen trays. The simplicity of the configuration allows the user to operate the sifting device 001 with ease and it is unlikely to have the trays arranged incorrectly. Therefore, the chance of accidental leakage of the litter material 002 or undesirable contact with the soiled litter material is minimized. Locking mechanism may also be implemented to ensure that the first and second screen trays 110, 120 are engaged in specific orientations.

Preferably and advantageously, the bases 112, 122, of the first and second screen trays 110, 120 with a sieve-like structure, have a plurality of openings 311, 321, arranged in a concentric, circular and intermittent manner to form a first and a second pattern respectively. The first pattern is different from the second pattern so as to allow the first and second screen trays 110, 120 to operate at a “close” mode or an “open” mode in accordance with the angle of rotation. Preferably, the first and second patterns are selected such that the first pattern is mirrored from the second pattern. Therefore, when the first and second screen trays 110, 120 are stacked together without rotation, the plurality of openings 311 of the first screen tray 110 are positioned relatively at the same location as the non-opening regions 312 of the second screen tray 120, and vice versa.

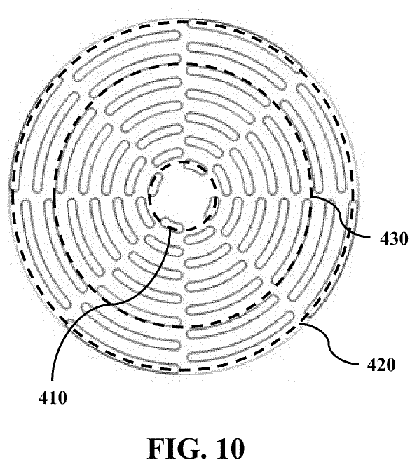

Now refer to FIG. 10, an exemplary pattern of the first screen tray 110 is depicted. In the configuration, the plurality of openings 311 is positioned along a plurality of concentric circular tracks having increasing radii from an innermost circular track 410 to an outermost circular track 420 and a common center 003. By this arrangement, the base 112 has a sieve-like structure. Each circular track is made up of a plurality of openings 311 with annular shapes and a plurality of non-opening portions 312, and there is a non-opening track 430 between every two circular tracks of different radii. In other words, the plurality of openings 311 and the non-opening portions 312 alternatively and repeatedly placed on each circular track intermittently. In the preferred configuration shown in FIG. 10, there are thirteen concentric circular tracks and twelve non-opening tracks 430, wherein each concentric circular track is alternatively formed by four openings 311 and four non-opening portions 312. The angle of rotation for switching the uppermost nested tray 100 between “open” and “close” mode is 360°/8=45°. As the circular tracks are having increasing radii, it is apparent that from the innermost circular track 410 to the outermost circular track 420, the length of the openings is increasing. In one embodiment, the arc lengths of the openings from the innermost circular track 410 to the outermost circular track 420 are 18.1 mm, 24.1 mm, 33.3 mm, 40.7 mm, 48.3 mm, 55.3 mm, 63.8 mm, 69.8 mm, 77.6 mm, 84.5 m, 85.8 m, 99.3 mm, and 107.2 m. The width of the openings is preferred not to be more than 7 mm and the depth of openings is 2.5 mm, such that the unsoiled litter material is permitted to pass through, while the animal waste with substantially larger size is not permitted to pass through. The risk of clogging is minimized as stickiness is usually scrubbed off during rotation and the depth of the openings is very low.

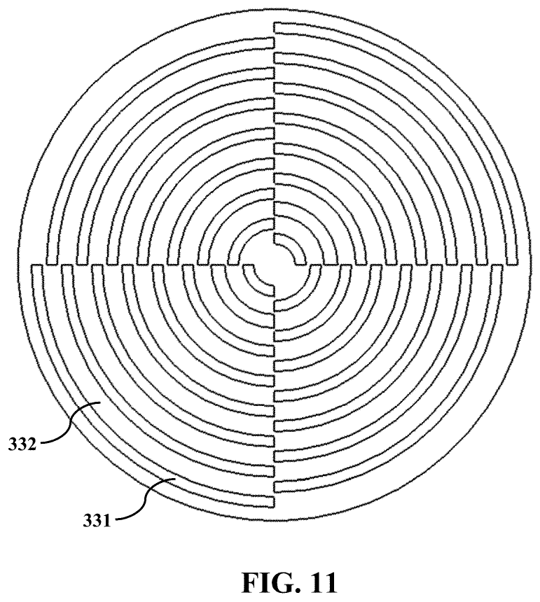

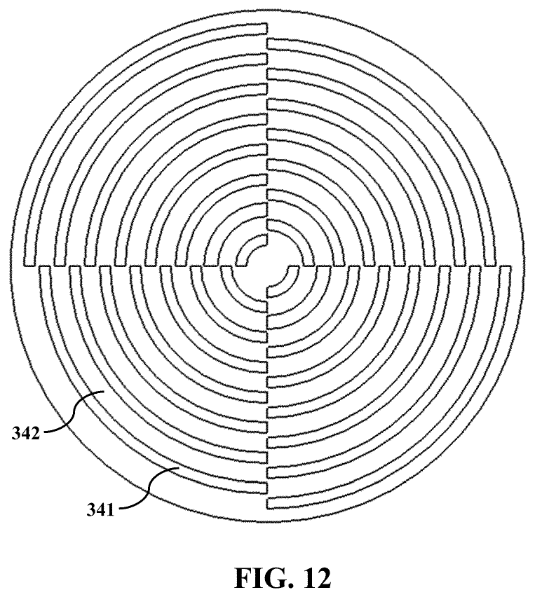

As noted by the Inventor, it is desirable to have a smaller angle of rotation so that the user is only required to turn a smaller angle when operating the sifting device 001. However, configuration of larger angle of rotation with less number of openings 311 and the non-opening portions 312 on each circular track is possible, as demonstrated in FIGS. 11-12. In this alternative embodiment, there are fifteen concentric circular tracks and fourteen non-opening tracks 430, wherein each concentric circular track is alternatively formed by two openings 311 and two non-opening portions 312. The angle of rotation for switching the uppermost nested tray 100 between “open” and “close” mode is 360°/4=90°.

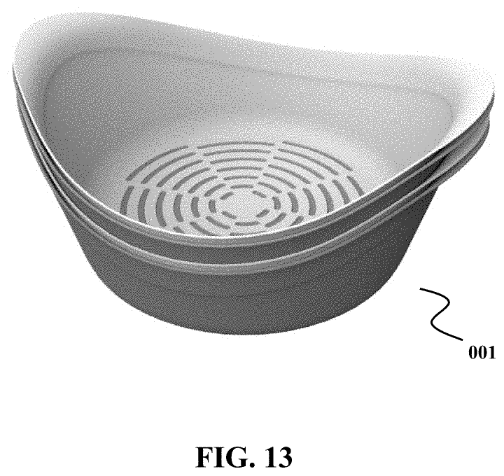

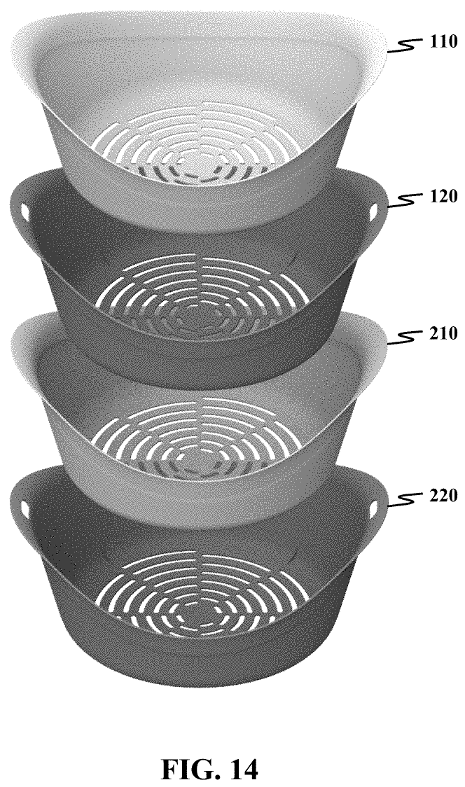

FIGS. 13-14 provide a 3D CAD model of the sifting device and an exploded perspective view thereof.

As explained above, according to the present disclosure, the following advantageous effect may be given. The sifting device 001 is easy to operate, where the animal waste can be separated from unsoiled litter material by rotating the first or the second screen tray 110, 120. The whole cleaning cycle takes less than 30 seconds, which is both efficient and effective. The configuration of the sifting device 001 is simple, and it is unlikely to have the trays arranged incorrectly. Therefore, the chance of accidental leakage of the litter material 002 or undesirable contact with the soiled litter material is minimized. Furthermore, the risk of clogging is minimized as stickiness is usually scrubbed off during rotation and the depth of the openings is very low.

As one useful application, the disclosed sifting device may be used as a potty for pet animals, such as domestic cats. The device as presently disclosed may also be used by other applications for other purposes. For example, it can be used for separating waste material, food ingredients, or other material with substantially different size.

Accordingly, various structures and devices for separating an unsoiled litter material from an animal waste are provided. While exemplary embodiments have been presented in the foregoing detailed description of the invention, it should be appreciated that a vast number of equivalent variations exist. It should also be appreciated that these exemplary embodiments are only examples, and are not intended to limit the scope, applicability, or configuration of the invention in any way. Rather, the foregoing detailed description will provide those skilled in the art with a convenient road map for implementing an exemplary embodiment of the invention. Various changes may be made in the function and arrangement of elements described in an exemplary embodiment without departing from the scope of the invention as set forth in the appended claims and their legal equivalents.

What is claimed is:

1. A sifting device for separating an unsoiled litter material from an animal waste, the sifting device comprising:
at least two nested trays configured to stack together, each nested tray comprising a first screen tray and a second screen tray stackable and rotatable to each other, each of the first and second screen trays having a base with a plurality of openings thereon, wherein:
an individual opening is sized to permit the unsoiled litter material to pass through, and to prevent the animal waste with a substantially larger size from passing through;
the plurality of openings on the first screen tray is arranged in a concentric, circular and intermittent manner to form a first pattern;
the plurality of openings on the second screen tray is arranged in a concentric, circular and intermittent manner to form a second pattern;
the plurality of openings on the first screen tray is blocked by the plurality of openings on the second screen tray to form an imperforate base when the first and second screen trays are stacked together and positioned to have the first and second patterns entirely non-overlapped; and
the first and second screen trays are rotatable to arrange the first and second patterns to be at least partially overlapped such that the base becomes a perforated base for allowing the unsoiled litter material to pass through.

2. The sifting device of claim 1, wherein a bottom nested tray of the at least two nested trays is arranged to form the imperforate base.

3. The sifting device of claim 1, wherein an uppermost nested tray of the at least two nested trays is arranged to form the perforated base for collecting the litter material in a nested tray lower than the uppermost nested tray, thereby enabling the uppermost nested tray to be emptied and cleaned after allowing the animal waste to be collected therein.

4. The sifting device of claim 1, wherein the first and second patterns are selected such that the first pattern is mirrored from the second pattern.

5. The sifting device of claim 1, wherein the individual opening has a width not more than 7 mm.

6. The sifting device of claim 1, wherein the plurality of openings is arranged along a plurality of concentric circular tracks having increasing radii from an innermost circular track to an outermost circular track intermittently.

7. The sifting device of claim 6, wherein each concentric circular track is alternatively formed by annular openings and non-opening portions.

8. The sifting device of claim 1, wherein each of the first and second screen trays has sidewalls bulging from the base upwardly and slightly outwardly to enable one screen tray stacked atop another screen tray to form an individual nested tray.

9. The sifting device of claim 8, wherein both the first second screen tray have one or more grips flared laterally outward from an upper rim of the sidewalls for facilitating lifting an uppermost nested tray of the at least two nested trays.

10. The sifting device of claim 1, wherein the at least two nested trays are substantially identical to and interchangeable with each other.

11. The sifting device of claim 1, wherein the animal waste comprises animal excrement and soiled litter material.

12. The sifting device of claim 1, wherein the sifting device is made from plastic, wood, or metal.
